(19) United States
(12) Patent Application Publication
(10) Pub. No.: US 2026/0185837 A1
(43) Pub. Date: Jul. 2, 2026

(54) METHOD AND SYSTEM FOR PROVIDING AI-ASSISTED NAVIGATION ASSISTANCE

(71) Applicant: Wipro Limited, Bangalore (IN)

(72) Inventors: Navya VEPAKOMMA, Bangalore (IN); Sreehari G. VARMA, Bangalore (IN)

(73) Assignee: Wipro Limited, Bangalore (IN)

(21) Appl. No.: 19/332,986

(22) Filed: Sep. 18, 2025

(30) Foreign Application Priority Data
Dec. 26, 2024 (IN) 202441103339

(51) Int. Cl. G01C 21/34

(52) U.S. Cl. CPC G01C 21/3453

(57) ABSTRACT

A method and a system for providing AI-assisted navigation assistance to a user within a region of interest (ROI) is disclosed. A processor receives one or more navigation queries from a user device. A first set of locations within the ROI is determined by querying a retrieval augmented generation (RAG) model based on query embeddings of the one or more navigation queries, global spatial embeddings relevant to the query embeddings, and first metadata associated to the global spatial embeddings. Further, the processor by employing one or more predefined functions determines a second set of locations within the ROI. A set of navigation instructions is determined to reach the at least one desired location from the second set of locations.

### Technical Field

This disclosure relates generally to navigation systems, and more particularly, to a navigation system and method for providing an AI-Assisted navigation assistance.

### BACKGROUND

Navigating intricate and bustling environments such as airports, shopping malls, hospitals, and convention center remains a significant challenge due to their vast layouts, high foot traffic, and limited spatial awareness among users. Passengers often struggle with wayfinding, especially during peak hours, leading to confusion, congestion, and delays. The lack of clear understanding of spatial relationships and inadequate crowd prediction mechanisms contribute to inefficient passenger flow and overcrowded areas. Additionally, users are frequently unaware of the available services within these environments, resulting in poor utilization of dwell time and a disconnected, impersonal experience. These issues collectively lead to increased stress for users, missed connections, operational inefficiencies, and a diminished reputation for the facility. Facility operators also face added inefficiencies and increased operational costs due to persistent crowd management challenges.

Therefore, there is a requirement of user-centric indoor navigation system that enhances wayfinding, service awareness, and crowd management in large, complex environments.

### SUMMARY OF THE INVENTION

In an embodiment, a method of providing AI-assisted navigation assistance to a user within a region of interest (ROI) is disclosed. The method may include receiving, by a processor, one or more navigation queries from a user device. In an embodiment, the one or more navigation queries may include a current location and one or more user preferences related to at least one desired location within the ROI. The method may further include determining, by the processor, a first set of locations within the ROI by querying a retrieval augmented generation (RAG) model based on query embeddings of the one or more navigation queries, global spatial embeddings relevant to the query embeddings, and first metadata associated to the global spatial embeddings. The method may further include determining, by the processor, by employing one or more predefined functions, a second set of locations within the ROI and based on an analysis of the first set of locations, the one or more user preferences, user information, and a local spatial layout of a subset of the ROI that may include the first set of locations. Further, the method may include determining, by the processor by using an LLM, a set of navigation instructions to reach the at least one desired location from the second set of locations based on the current location of the user.

In another embodiment, a system for providing AI-assisted navigation assistance to a user within a region of interest (ROI) is disclosed. The system may include a processor, and a memory communicatively coupled to the processor, wherein the memory stores processor-executable instructions, which on execution, cause the processor to receive one or more navigation queries from a user device. In an embodiment, the one or more navigation queries may include a current location and one or more user preferences related to at least one desired location within the ROI. Further, the processor may determine a first set of locations within the ROI by querying a retrieval augmented generation (RAG) model based on query embeddings of the one or more navigation queries, global spatial embeddings relevant to the query embeddings, and first metadata associated to the global spatial embeddings. Further, the processor may determine by employing one or more predefined functions, a second set of locations within the ROI and based on an analysis of the first set of locations, the one or more user preferences, user information, and a local spatial layout of a subset of the ROI that may include the first set of locations. The processor may further determine by using an LLM a set of navigation instructions to reach the at least one desired location from the second set of locations based on the current location of the user.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates a block diagram of an exemplary system for providing AI-assisted navigation assistance to a user within a region of interest (ROI), in accordance with an embodiment of the present disclosure.

FIG. 2A illustrates an exemplary map of the exemplary ROI, in accordance with an exemplary embodiment of the present disclosure.

FIG. 2B illustrates an exemplary table of a CSV file, in accordance with an exemplary embodiment of the present disclosure.

FIG. 2C illustrates an exemplary network-based layout of the ROI, in accordance with an exemplary embodiment of the present disclosure.

FIG. 2D illustrates an exemplary global spatial embeddings of the ROI, in accordance with an exemplary embodiment of the present disclosure.

FIG. 3 illustrates a functional block diagram of the agent framework unit of FIG. 1, in accordance with an embodiment of the present disclosure.

FIG. 4 illustrates an exemplary caller function, in accordance with an exemplary embodiment of the present disclosure, in accordance with an embodiment of the present disclosure.

FIG. 5 illustrates a flow diagram depicting a methodology of providing AI-assisted navigation assistance to a user within a ROI, in accordance with an embodiment of the present disclosure.

FIG. 6 illustrates a flow diagram of a methodology of determining a second set of locations as determined in FIG. 5, in accordance with an embodiment of the present disclosure.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered as exemplary only, with the true scope being indicated by the following claims. Additional illustrative embodiments are listed.

Further, the phrases “in some embodiments”, “in accordance with some embodiments”, “in the embodiments shown”, “in other embodiments”, and the like, mean a particular feature, structure, or characteristic following the phrase is included in at least one embodiment of the present disclosure and may be included in more than one embodiment. In addition, such phrases do not necessarily refer to the same embodiments or different embodiments. It is intended that the following detailed description be considered exemplary only, with the true scope and spirit being indicated by the following claims.

Since current navigation methods such as static maps or modern AR overlays often lack the ability to account for individual preferences and the user's region of interest, they fail to deliver a truly intuitive navigation experience. Therefore, the current solution of utilizing graph representation of spaces by modeling complex spatial relationships between various locations within an environment, enabling more context-aware and user-relevant navigation methods as discussed in detail in the current disclosure overcomes the problems discussed above.

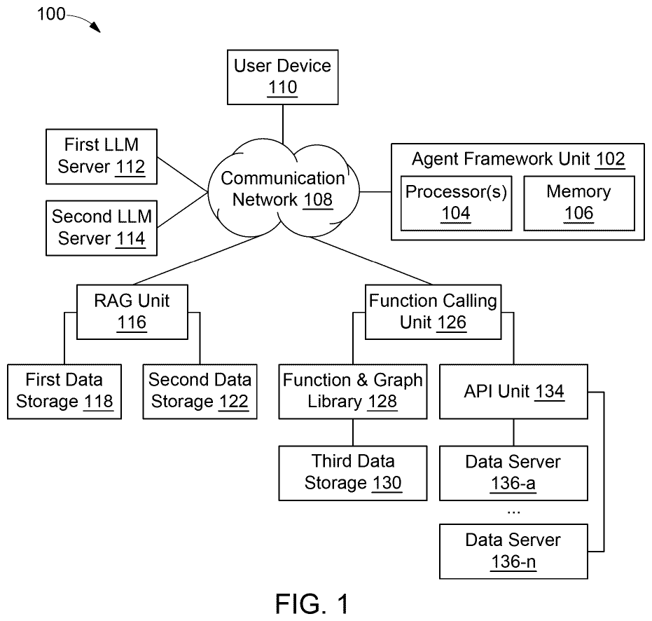

Referring now to FIG. 1, a block diagram of an exemplary system 100 for providing AI-assisted navigation assistance to a user within a region of interest (ROI), is illustrated, in accordance with an embodiment of the present disclosure. The system 100 may include an agent framework unit 102, a user device 110, a first Large Language Model (LLM) server 112, a second LLM server 114, a Retrieval-Augmented Generation (RAG) unit 116 and a function calling unit 126 communicatively coupled to each other through a wired or wireless communication network 108.

In an embodiment, the communication network 108 may be a wired or a wireless network or a combination thereof. The communication network 108 can be implemented as one of the different types of networks, such as but not limited to, ethernet IP network, intranet, local area network (LAN), wide area network (WAN), the internet, Wi-Fi, LTE network, CDMA network, 5G and the like. Further, the communication network 108 can either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the communication network 108 can include a variety of network devices, including routers, bridges, servers, computing devices, storage devices, and the like.

The agent framework unit 102 may be a computing device that may include a processor 104, and a memory 106. In an embodiment, examples of processor(s) 104 may include, but are not limited to, microcontrollers, microprocessors, digital signal processors (DSPs), application-specific integrated circuits (ASICs), field-programmable gate arrays (FPGAs), system-on-chip (SoC) components, or any other suitable programmable logic devices. Examples of processor(s) 104 may include but are not limited to, an Intel® Itanium® or Itanium 2 processor(s), or AMD® Opteron® or Athlon MP® processor(s), Motorola® lines of processors, Nvidia®, FortiSOC™ system on a chip processors or other future processors. In an embodiment, the memory 106 may be a computer-readable medium (CRM) that may store non-transitory computer-readable instructions. In an embodiment, the memory 106 may be a non-volatile memory or a volatile memory. Examples of non-volatile memory may include but are not limited to, a flash memory, a Read Only Memory (ROM), a Programmable ROM (PROM), Erasable PROM (EPROM), and Electrically EPROM (EEPROM) memory. Further, examples of volatile memory may include but are not limited to, Dynamic Random Access Memory (DRAM), and Static Random-Access memory (SRAM).

In an embodiment, the user device 110 may be a computing device such as, but not limited to, a mobile phone, tablet, laptop, wearable device, or any other computing device capable of providing the front-end for user interaction and communication over the communication network 108. The user device 110 may further include sensors, input/output interfaces, and display units to facilitate contextual navigation experiences. Further, the user device 110 may be used by a user to input one or more navigation queries to the agent framework unit 102 to determine a set of navigation instructions to at least one desired location. It may be noted that the one or more navigation queries may include a current location and one or more user preferences related to at least one desired location within the ROI. In an example, an ROI may be one or more architectural buildings where the user is currently present such as, but not limited to, an airport, mall, or any commercial or residential complex.

In an embodiment, the agent framework unit 102 may be communicably coupled with the first LLM server 112 and the second LLM server 114 through the communication network 108.

In an embodiment, the first LLM server 112 and the second LLM server 114 may be enabled in a remote cloud server or a co-located server and may employ one or more Large Language Models (LLMs). The first LLM server 112 may employ a first LLM to generate vector embeddings corresponding to the one or more navigation queries received by the agent framework unit 102 from the user device 110. Examples of the first LLM may include but are not limited to, Generative Pre-trained Transformer (GPT), Large Language Model Meta AI (Llama), Bidirectional Encoder Representations from Transformers (BERT), Cohere, etc. In an embodiment, the first LLM server 112 may upon receiving the one or more navigation queries from the agent framework unit 102 and may send the query embeddings corresponding to the one or more navigation queries to the agent framework unit 102.

In an embodiment, the RAG unit 116 may be enabled in a remote cloud server or a co-located server and may perform spatial query processing by combining retrieval-based and generative techniques.

The RAG unit 116 may manage the retrieval of relevant spatial data by matching the query embeddings corresponding to the one or more navigational queries to identify the most contextually relevant information. Examples of RAG unit 116 may enable one or more RAG models such as, but not limited to Text-Based RAG, Graph-Based RAG, Tabular RAG, Multimodal RAG, Real-Time RAG, Personalized RAG, Memory-Augmented RAG, Fusion-in-Decoder (FiD) RAG, Token RAG, Sequence RAG, Domain-Specific RAG etc. In an embodiment, the RAG unit 116 is communicably coupled to a first data storage 118 and a second data storage 122 via a wireless or a wired communication network (not shown). The first data storage 118 may include global spatial embeddings and the second data storage 122 may include space metadata and other data necessary for the RAG unit 116. In an embodiment, the first data storage 118 and the second data storage 122 may be deployed on cloud servers or may be enabled as physical databases communicably coupled to the RAG unit 116. In an embodiment, the global spatial embeddings may be determined based on a network-based layout of the ROI. It is to be noted that the network-based layout may include but not limited to, a plurality of nodes, one or more neighbors associated with each of the plurality of nodes and weighted spatial relationships between each of the plurality of nodes. The global spatial embeddings may be in a vector format and generated using algorithms such as node2vec, enabling representation of spatial relationships between nodes in vector form. The vector database supports efficient similarity search for identifying a plurality of nodes, one or more neighbors associated with each of the plurality of nodes and weighted spatial relationships between each of the plurality of nodes based on embeddings corresponding to the one or more navigational queries. It may be optimized for fast nearest neighbor search operations and maintains appropriate indexing mechanisms to facilitate rapid retrieval of relevant spatial node embeddings. This database supports semantic spatial matching by the RAG models of the RAG unit 116.

Further, it is to be noted that the space metadata also referred to as the first metadata may include, but not limited to, operational metadata associated with each of the plurality of nodes in a JSON format. Examples of operational metadata may include, but not limited to, contextual and descriptive attributes such as accessibility features, space type, crowd level or footfall data, noise level, lighting conditions, operating hours, occupancy attributes relevant to the user's region of interest, auxiliary information such as semantic tags, security level, maintenance schedules, sensor data logs, usage trends or the like, necessary for spatial reasoning and decision-making and the like. The global spatial embeddings stored in the first data storage 118 and the space metadata stored in the second data storage 122 may be periodically updated at defined intervals to ensure accuracy and relevance of the responses generated by the system 100.

Therefore, the RAG unit 116 may receive the query embeddings of the one or more navigation queries and may query the first data storage 118 and the second data storage 122 to retrieve a first set of locations within the ROI based on the query embeddings, global spatial embeddings relevant to the query embeddings, and first metadata associated with the global spatial embeddings.

Further, the agent framework unit 102 may be communicably connected to the function calling unit 126. Further, the function calling unit 126 is communicably coupled to a function & graph library 128 and an Application Programming Interface (API) unit 134. Further, the function & graph library 128 is communicable coupled to a third data storage 130. The third data storage 130 may include a local spatial layout of the ROI in GraphML file format. Further, third data storage 130 maintains the spatial layouts by supporting periodic updates and enabling periodic loading in existing networks and saving any modifications or enhancements made during spatial processing or analysis. Further, the function & graph library 128 may include a repository of specialized functions related to, but not limited to, pathfinding and analysis functions, for spatial analysis of the local spatial layouts. Further, the function & graph library 128 may include a Graph Library for graph-based operations, various graph algorithms and metrics calculations.

Further, the function calling unit 126 is communicably coupled to an API unit 134. The API unit 134 is communicably coupled to one or more data servers 136-a-136-n. The function calling unit 126 may receive user information and real-time data associated with the first set of locations by requesting the one or more servers 136-a-136-n via the API unit 134. Thus, the API unit 134 facilitates smooth integration of the one or more data servers 136a-n into the system 100. Examples of real-time data may include, but not limited to, inventory information, crowd monitoring information, promotion information, event information, live operational status, and status updates. Further, example of user information may include, but is not limited to, demographic information of the user and historical user data.

In an embodiment, the API unit 134 may receive requests for real-time synchronization of data from the one or more data servers 136a-136n from the function calling unit 126. Accordingly, the function calling unit 126 may receive the user information and real-time data associated with the first set of locations by requesting one or more data servers 136a-136n via the API unit 134.

Further, the function calling unit 126 may call one or more predefined functions by securely connecting to one or more external applications via the API unit 134. Further, the function calling unit 126 may determine by employing the one or more predefined functions one or more parameters related to the one or more user preferences based on a processing of the user information, the first set of locations, the one or more user preferences, the local spatial layout of the subset of the ROI, the current location of the user and the real-time data.

Accordingly, the agent framework unit 102 may determine, by employing the one or more predefined functions called by the function calling unit 126, a second set of locations within the ROI and based on an analysis of the first set of locations, the one or more user preferences, the user information, and the local spatial layout of a subset of the ROI that comprises the first set of locations. Further, the agent framework unit 102 may determine a set of navigation instructions to reach the at least one desired location from the second set of locations based on the current location of the user by querying a second LLM enabled by the second LLM server 114.

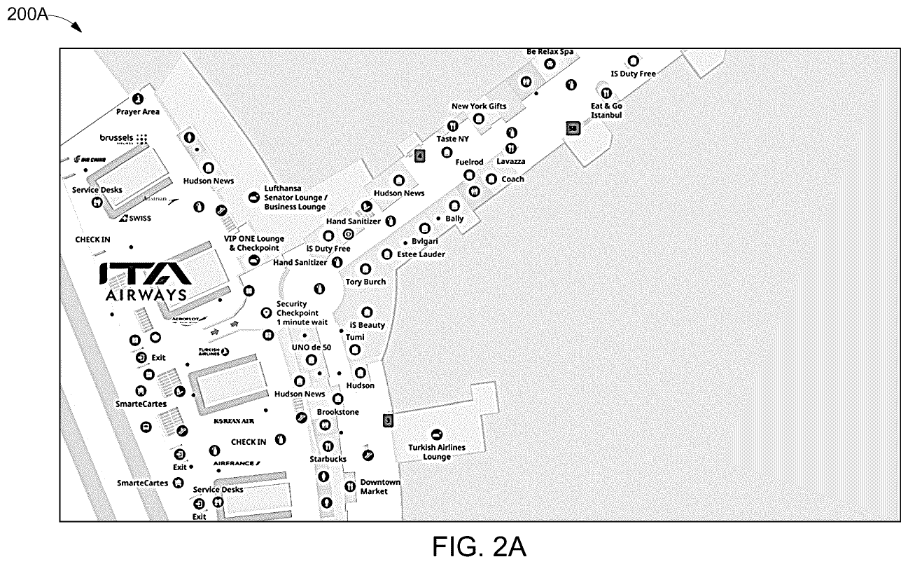

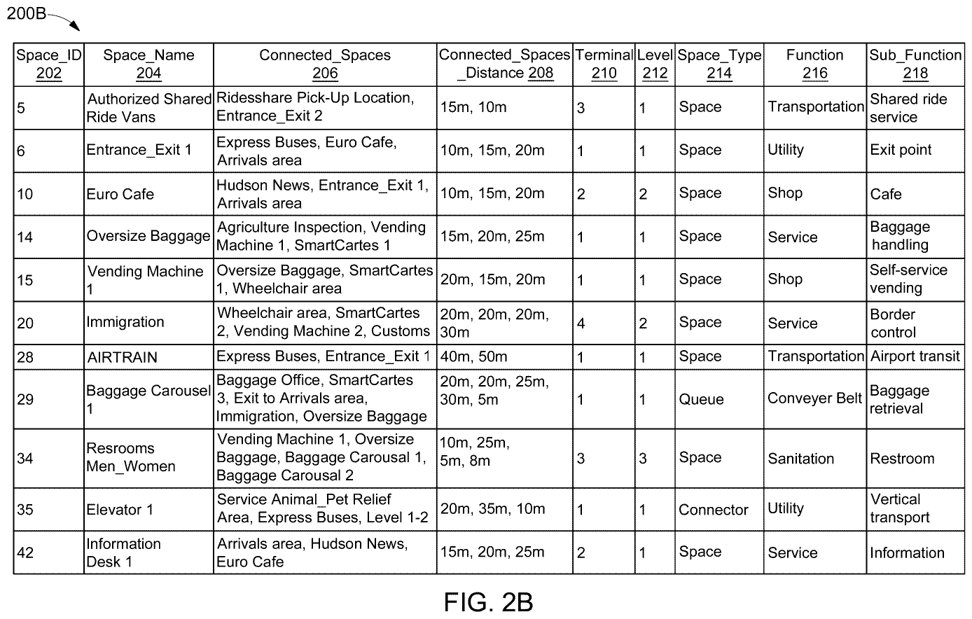

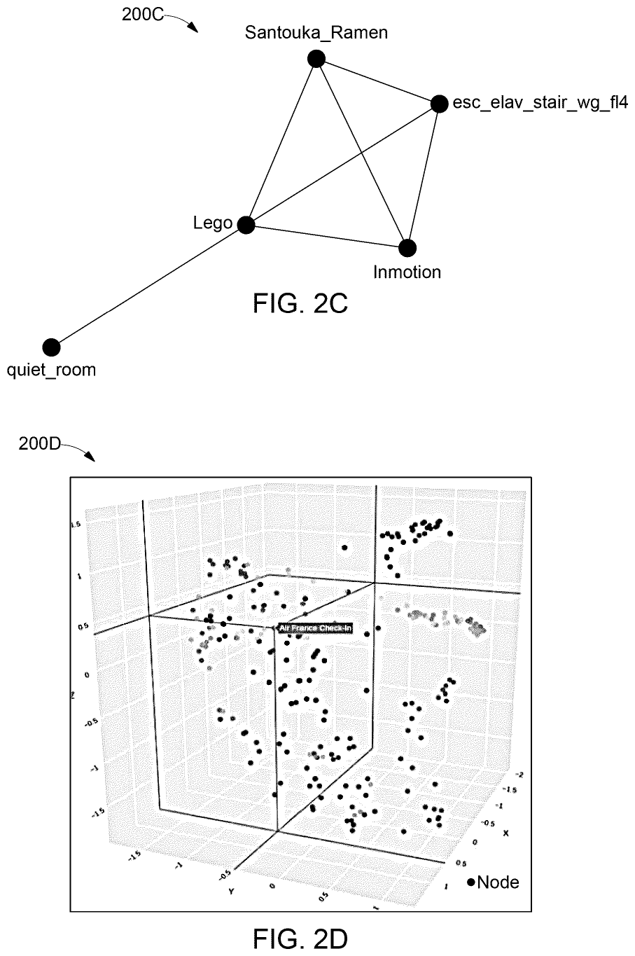

Referring now to FIG. 2A, an exemplary map 200A of the exemplary ROI is illustrated, in accordance with an exemplary embodiment of the present disclosure. It may be noted that the local spatial layouts and the global spatial layouts may be determined based on the exemplary map 200A. In accordance with the exemplary scenario of the ROI being an airport, the map 200A of the airport may be determined based on the current location of the user from the first data storage 118 or the second data storage 122. A scanned image or blueprints of a map of the ROI may be parsed to convert them into digital graphs. A combination of automated tools and manual inputs such as agent-based vision models (for example, GPT Vision or Claude 3.5 Sonnet) may be used to process digital or scanned airport maps, in order to identify and categorize all types of spaces, and store them into a structured format such as a csv file. Human experts may then review and refine the csv file generated to ensure accuracy and add relevant metadata. In accordance with the exemplary scenario of the ROI being an airport, the map may include, but not limited to, detailed mapping of terminal details, gates, security checkpoints, retail and dining locations, restrooms, lounges, and other amenities, along with walkways and transportation systems such as elevators, escalators, moving walkways, shuttle services, and other passenger transport facilities, etc.

Referring now to FIG. 2B, an exemplary table 200B of a CSV file is illustrated, in accordance with the exemplary embodiment of the present disclosure. As can be seen, the table 200B lists a plurality of nodes determined from the exemplary map 200A. Each of the plurality of nodes in the table 200B may be uniquely identified using a Space_ID 202 and a Space_Name 204. For each node in the table 200B, one or more neighbors are listed in the Connected_Spaces column 206. Further, a distance between each node and the connected one or more neighbors is provided as connected_space distance 208. A nearest terminal 210 to each of the plurality of node is provided and a level 212 on which each of the plurality of node is present is provided. Further, a space_type 214 may provide a category of each node. Further, function 216 and sub-function 218 may provide a functional information associated to each of the nodes. For example, if a node is associated to a function ‘utility’ and that ‘utility’ may have a sub-function of being an ‘exit point’. It may be noted that one or more of the connected_space distance 208, the nearest terminal 210, the level 212, the space_type 214, the function 216 and sub-function 218 information for each of the plurality of nodes may be used to determine weighted spatial relationships between each node and its neighbors.

Referring now to FIG. 2C, an exemplary network-based layout 200C of the ROI is illustrated, in accordance with the exemplary embodiment of the present disclosure. The network-based layout 200C may be generated by using python scripts over NetworkX library. It may be noted that the network-based layout 200C may include a plurality of nodes, one or more neighbors associated with each of the plurality of nodes and weighted spatial relationships between each of the plurality of nodes. In accordance with the exemplary embodiment where the ROI is an airport, the nodes may represent distinct spaces within a facility, such as gates, retail stores, or service counters. The edges between each of the plurality of nodes may represent walkable paths and may be assigned weights based on factors such as, but not limited to, distance, estimated walking time, accessibility and so on. Further, each of the plurality of nodes may be associated with metadata stored in textual form, separate from the graph structure, and maintained in a JSON format. The metadata may be updated more frequently than the underlying graph database including, for example, operating hours for retail locations, types of services offered, or, in the case of a restaurant space, information relating to menus and pricing and so on. The network-based layout 200C may be used for determining the global spatial embeddings and the local spatial layout retrieval of both the spatial relationships between spaces and the associated metadata from CSV data for use in navigation, service discovery, or operational management. Thus, the graph generation process encodes spatial parameters, such as distances and connection types (e.g., walkway, moving walkway), for efficient navigation and query operations. For example, a section of the graph may include: Node: “Gate A1”→Edge (distance: 10 m, type: “walkway”)→Node: “A Concourse Junction”→Edge (distance: 15 m, type: “moving walkway”)→Node: “Central Atrium.” Each node is further linked to associated metadata in JSON format, stored separately from the graph, and retrievable as needed. Such metadata may include, for example, operating hours, available services, or restaurant details such as menu and pricing, and can be updated independently from the graph database for real-time accuracy. It is to be noted that this data forms a graph, with nodes as spaces and edges as links between them. Further, edge weights enable computations such as navigation, route optimization, and spatial queries.

Referring now to FIG. 2D, an exemplary global spatial embeddings 200D of the ROI is illustrated, in accordance with the exemplary embodiment of the present disclosure. It may be noted that the global spatial embeddings 200D of the ROI being an airport may be determined by utilizing functions such as, but not limited to, “node2vec” or a similar graph embedding technique to convert the spatial graph into a high-dimensional vector space. Used herein, the high-dimensional vector space is an embedding space where each node representing a physical location: “Gate A1” or “Starbucks” (shown as dots in FIG. 2D)) in the spatial graph is transformed into a vector. Used herein, the terms “airport graph”, “spatial graph”, “space network graph” and “network-based layout” can be used interchangeably throughout the document. It may be noted that an embedding dimension may be defined such as, but not limited to, 64 or 768, a walk length and number of walks per node may be specified for generating the embeddings (i.e., node embeddings) for each node in the graph, and for generating random walks. Further, these random walks performed across the graph and resulting node sequences may be used to train model that produces vector representations for each node. Used herein, the node sequences capture the spatial context of each node by simulating how a person or user might traverse across different nodes in the graph. The term “spatial node embeddings”, “spatial embeddings” and “node embeddings” can be used interchangeably.

Thus, the resulting embeddings: (i) capture both the structural and functional relationships between different locations of the airport, (ii) support similarity search for matching user queries to relevant nodes of a spatial graph, and facilitate computation for pathways and personalization tasks.

For example, the vector for “Gate A1” might be close to other nearby gates and related facilities in the vector space. Further, the generated embeddings may be converted into a NumPy matrix wherein each row may represent a node in the spatial graph, and each column may represent a dimension in the embedding space. A mapping may be created between node identifiers and their corresponding row indices in the matrix to generate and save the matrix to a file for retrieval. In one example, the matrix can be a NumPy matrix is also saved in a space graph network database (not shown), which stores the complete spatial graph network of airports in GraphML format, thereby enabling loading and saving for graph modifications.

This NumPy matrix supports downstream task such as matching the user query against the node embeddings. As a specific example, when a user submits a query (e.g., “fastest route to Starbucks”), it is converted into an embedding using LLM. The Graph-based RAG model performs a similarity search between the query embedding (in the user query) and node embeddings (in NumPy matrix). Then the relevant nodes (e.g., Starbucks, Dunkin Express) are identified based on semantic and spatial relevance. The relevant nodes are used to compute personalized paths using graph algorithms. Further, metadata (e.g., crowd levels, operating hours) is also retrieved and factored into the pathfinding.

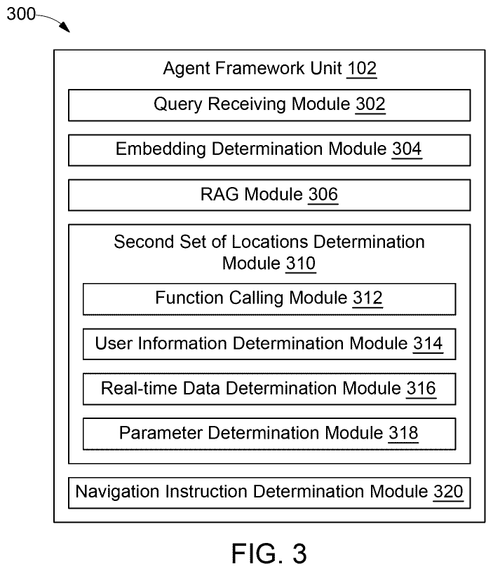

Referring now to FIG. 3, a functional block diagram 300 of the agent framework unit 102 of the system 100 of FIG. 1 is illustrated, in accordance with the embodiments of the present disclosure. FIG. 3 is explained in conjunction with FIGS. 1, 2A-2D. The memory 106 of the agent framework unit 102 may include a query receiving module 302, an embeddings determination module 304, a RAG module 306, a second set of locations determination module 310, and a navigation instruction determination module 320. The second set of locations determination module 310 may further include a function calling module 312, a user information determination module 314, a real-time determination module 316, and a parameter determination module 318.

The query receiving module 302 may receive one or more navigation queries from the user device 110. The one or more navigation queries may include, but not limited to, a current location of the user device 110 and one or more user preferences related to at least one desired location within the ROI. In one example, the one or more user preferences may include information such as, but not limited to, user behavioral history, spatial constraints, environmental conditions, user defined goals or system-defined goals, landmark-based direction query, real-time condition input, service information request query, comparative analysis query, contextual navigation query, user mobility infrastructure query and so on.

In an exemplary embodiment, the one or more navigation queries as input by a user present at an airport may be “What's the fastest route from Gate A1 to the nearest coffee shop?” or “What's the fastest route from Gate A1 to Sterbuck with least crowd?”

Thus, in accordance with the exemplary embodiment, from the one or more navigation queries it may be noted that the ROI is an airport where the user device 110 may be located and a desired location includes a coffee shop or a place named “Sterbuck”. Further, the user preferences include that the desired location should be nearest from Gate A1 or should have least crowd.

The embeddings determination module 304 may determine the query embeddings of the one or more navigation queries received by the query receiving module 302, by prompting the first LLM enabled by the first LLM server 112. It is to be noted that the query embeddings are the vector representations of the one or more navigation queries that may be used to semantically align user intent with spatial data for determining relevant outcome.

The RAG module 306 may determine a first set of locations within the ROI by querying a retrieval augmented generation (RAG) model based on the query embeddings of the one or more navigation queries, global spatial embeddings 200D relevant to the query embeddings, and first metadata associated to the global spatial embeddings 200D. It may be noted that global spatial embeddings 200D relevant to the query embeddings are determined by the RAG model through a similarity matching process. When the RAG unit 116 receives the query embeddings from the first LLM server 112, it may perform a vector similarity search against the global spatial embeddings 200D stored in the first data storage 118. This search identifies embeddings with the highest semantic similarity to the query embeddings using techniques such as cosine similarity or nearest neighbor algorithms. The RAG model then retrieves these relevant global spatial embeddings, which represent spatial nodes and their relationships within the ROI, along with their associated metadata from the second data storage 122. This process enables the system to identify the most contextually appropriate spatial information based on the user's navigation query, effectively bridging the semantic gap between natural language queries and the underlying spatial representation of the environment.

In one example, the global spatial embeddings saved in the first data storage 118 are determined based on a network-based layout of the ROI. It is to be noted that the network-based layout may include a plurality of nodes, one or more neighbors associated with each of the plurality of nodes and weighted spatial relationships between each of the plurality of nodes. The network-based layout represents the physical and logical connections between different locations within the ROI, where each node corresponds to a specific location or point of interest such as gates, retail shops, restaurants, or service facilities. The neighbors associated with each node represent directly accessible adjacent locations, while the weighted spatial relationships capture metrics such as physical distance, estimated travel time, or accessibility factors between connected nodes. This graph-based representation enables efficient pathfinding algorithms to determine optimal routes based on various criteria including shortest distance, least crowded paths, or paths with specific amenities. The global spatial embeddings transform this graph structure into high-dimensional vector representations that preserve the topological relationships between locations, allowing for semantic similarity searches and contextual understanding of spatial relationships within the navigation system.

Further, the first metadata may include, but not limited to, operational metadata associated with each of the plurality of nodes in a JSON format. Additionally, the operational metadata may further include, but not limited to, static and dynamic information about the nodes such as operating schedules, service catalog information, cost structure information, user satisfaction indicators, facility classification information, contextual information (for example, overall atmosphere, seating availability, accessibility features that support ease of access for people with special needs) and so on associated within the ROI.

In one embodiment, the RAG module 306 may be a Graph-based RAG model which may utilize an AI-based similarity search, such as, but not limited to, the Facebook AI Similarity Search (FAISS), to retrieve relevant graph embeddings related or relevant to the query embeddings from the global spatial embeddings saved in the first data storage 118. As discussed earlier, the global spatial embeddings may store vector representations (embeddings) of graph elements, and may include nodes and edges, generated using techniques such as node2vec or the like.

In one example, upon receiving the query embedding, the RAG module 306 may perform a similarity search to identify the most contextually relevant graph embeddings related to the query using node2vec. Further, the above steps may return, a plurality of nodes, one or more neighbors associated with each of the plurality of nodes and weighted spatial relationships between each of the plurality of nodes. In accordance with the exemplary embodiment, if the user query is: “What's the fastest route from Gate A1 to the nearest coffee shop?” The RAG module 306 may perform a similarity search and may find nodes related to the user's query (coffee shop) embeddings along with a similarity score as below:
□ Starbucks: 0.874
□ Dunkin Express: 0.736
□ Express Coffee: 0.702
Further, the RAG module 306 may query the space metadata saved in the second data storage 122 to retrieve the first metadata that may be associated with each of the plurality of nodes in a JSON format. The RAG module 306 may determine first metadata relevant to the relevant nodes, such as operating hours and menu etc. Further, the first metadata may be a contextual package including the spatial relationship between Gate A1 and the coffee shops—Starbucks, Dunkin Express and Express Coffee along with relevant metadata for first example.
   In accordance with the exemplary embodiment, if the user query is: “I would like to find the best path from Gate A1 to Starbucks with least crowding.” The RAG module 306 may perform a similarity search to find nodes related to the user's query (coffee shop) embedding along with a similarity score as below:
□ Starbucks: 0.874

Further, the RAG module 306 may determine first metadata associated with “Starbucks”, such as operating hours and menu etc. as the contextual package. Thus, based on the similarity matching, the RAG module 306 facilitates efficient navigation and information retrieval within the region of interest (ROI) based on the query embeddings. Furthermore, this contextual package, i.e. a plurality of nodes, one or more neighbors associated with each of the plurality of nodes and weighted spatial relationships between each of the plurality of nodes, and the first metadata is utilized by the second set of locations determination module 310. It is to be noted that this first set of locations is an intermediate output containing the plurality of nodes, the one or more neighbors associated with each of the plurality of nodes and the weighted spatial relationships between each of the plurality of nodes, and the first metadata.

Accordingly, the second set of locations determination module 310 may determine a second set of locations within the ROI and based on an analysis of the first set of locations, the one or more user preferences, user information, and a local spatial layout of a subset of the ROI that comprises the first set of locations. It is to be noted that the second set of locations may be the refined and/or final set of locations within the ROI that are most relevant to the one or more navigation queries.

In one embodiment, exact names or references of the spatial references of the first set of locations determined by the RAG module 306 may be determined by querying a database (not shown) storing embeddings of names of a plurality of nodes. In one embodiment, node embeddings of the spatial references of the first set of locations may be determined by the embeddings determination module 304. Further, the third data storage 130 may include embeddings of names of a plurality of nodes which may be queried based on the node embeddings to determine the exact names of the nodes as determined by the RAG module 306. In an embodiment, the analysis of the first set of locations may include correcting the typing error of the embeddings corresponding to the names of the nodes in the list of node names output by the RAG module 306.

For example, for user's query such as “I would like to find the best path from Gate A1 to Sterbuck with least crowding.” The RAG module 102 may recognize “Gate A1” and “Sterbuck” as possible nodes in the ROI. The second set of locations determination module 310 may identify names of the nodes based on the embeddings corresponding to the first set of locations based on a similarity search for the input words by searching embeddings corresponding to the names of the nodes stored in the third data storage 130. In accordance with the above example, name of “Gate A1” may be determined as “Gate A1” and name of “Sterbuck” may be determined as “Starbucks”.

Further, the names determined may be replaced in the user's query therefore any typographical mistakes may also be corrected. The second locations determination module 310 may include a function calling module 312, a user information determination module 314, a real-time data determination module 316, a parameter determination module 318 and second metadata determination module 320. In an example, the agent framework unit 102 understands the presence of node “Gate A1” and associates it with the space in airport.

Further, the second set of locations determination module 310 may include the function calling module 312 that may call one or more predefined functions by securely connecting to one or more external applications via the function calling unit 126. It is to be noted that the second set of locations determination module 310 possesses sufficient information to select the appropriate registered caller function and its corresponding arguments. Further, the second set of locations determination module 310 may be powered by LLM that may have inherent capability to choose relevant functions based on the available context (for example: Open AI's tool calling etc.). In accordance with the exemplary navigation query “I would like to find the best path from Gate A1 to Starbucks with least crowding.” The second set of locations determination module 210 may identify one or more predefined functions as one or more python functions that may interact with the graph embeddings 200D. In one embodiment, the one or more predefined functions may use “networkX library” to fetch graph algorithms necessary for manipulating and interacting with the airport graph 200C. Further, functions such as ‘shortest_path_length(G, source=None, target=None, weight=None, method=‘dijkstra’)’ may be invoked to calculate shortest paths between nodes in the network-based layout 200C. Further, node attributes may be determined from the network-based layout 200C by invoking function “get_node_attributes(G, name, default=None)”. Further, eccentricity may determine for a node using function ‘eccentricity(G, v=None, sp=None, weight=None)’ such that the eccentricity of a node ‘v’ is the maximum distance from ‘v’ to all other nodes in G, wherein ‘G’: Graph. Further, a shortest path distance with least crowd may be determined between spaces in the network-based layout 200C using function “shortest_path_with_least_crowd(G, source=‘Gate A1’”, wherein Source: ‘Gate A1’ and Destination: ‘Starbucks’.

Accordingly, the one or more predefined functions may be converted into JSON schema for function registration with the function calling module 312. It may be noted that the JSON schemas may define the input and output of each function, for example:

{“name”: “shortest_path”, “description”: “Find the shortest path between two nodes in the airport”, “parameters”: {“type”: “object”, “properties”: {“start”: {“type”: “string”, “description”: “Starting node ID”}, “end”: {“type”: “string”, “description”: “Ending node ID”}}, “required”: [“start”, “end”]}},

These JSON schemas may be used to register the one or more predefined functions with the function calling module 312, allowing it to understand the capabilities of the graph interaction functions and for calling them appropriately by selecting the right arguments.

It may be noted that the function calling module 312 may utilize the one or more predefined functions to analyze and calculate graph metrics (e.g., pathfinding, centrality) saved in the third data storage 130. Further, the function calling module 312 may access real-time data (e.g., flight stats, on-floor crowd monitoring) from the real-time data determination module 316 to integrate called functions using the API unit 134. Thus, the function calling module 312 may implement a ‘caller function’ or ‘called function’ paradigm.

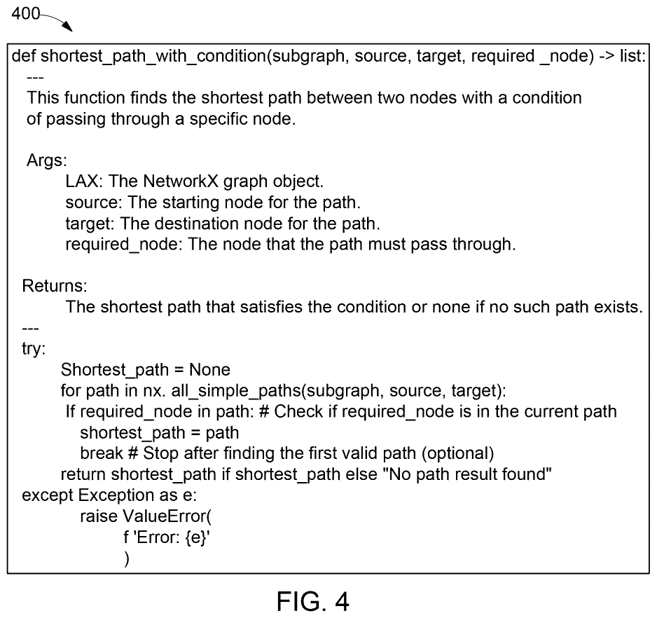

Referring now to FIG. 4, an exemplary caller function 400 is depicted, in accordance with an exemplary embodiment of the present disclosure. The exemplary caller function 400 provides a structure for finding a path with a particular condition to have an intermediate location within the path calculated between source and destination. It may be noted that a caller function can have multiple other functions (called functions) used as per the design functionality. Thus, a caller function is a specific function designed to achieve a particular objective. For example, an objective may be to find the best path from source to destination. Accordingly, a detailed caller function may be defined whose input arguments and return output are pre-determined and designed for the requirement.

Once the caller function is defined, it needs to be registered with the function calling module 312. This registration process may involve providing information such as: Function Purpose: A clear description of what the function is intended to do. For example, “Finds the shortest path between two nodes in a graph.”

Required Arguments: A list of the input parameters that the function expects. For example, source, destination, and graph in accordance with the example.

Expected Return Items: A description of the output that the function may return. For example, it's a list of nodes representing the shortest path.

Error Handling: A plan for how the function will handle unexpected errors or exceptions. This may include logging errors, raising exceptions, or returning specific error codes, etc.

Referring back to FIG. 3, a caller function as called by the function calling module 312 may internally call relevant pre-defined functions (called functions) from the function & graph library unit 128 that may include, but not limited to, pathfinding algorithms (called functions). Further, the function calling module 312 may connect to a crowd monitoring system (e.g., current crowd levels, out-of-order facilities) via the API unit 134. Thus, the one or more predefined functions may be called by securely connecting to one or more external applications via the API unit 134. It may be noted that the API unit 134 may be communicably connected to various crowd monitoring systems such as, but not limited to, on-floor crowd monitoring systems, data-driven crowd monitoring systems, etc. for forecasting and predicting crowds at different areas of the ROI. Example of on-floor crowd monitoring systems and data-driven crowd monitoring systems may enable, but not limited to, the CCTV based crowd monitoring, mobile Wi-Fi based crowd monitoring, dedicated sensor-based crowd monitoring, historical data-based crowd predictions, etc. Further, in accordance with the exemplary embodiment, where the ROI is an airport, the API unit 134 may be communicably connected to systems such as, but not limited to, flight information system, airport information system, promotions and events tracking system, and so on. In an example, the flight information system may be used to determine information such as, but not limited to, gate changes, flight delays in context of airports. Further, the flight information system may leverage third-party flight information providers to obtain real-time flight details via the API unit 134. Thus, when a navigation query from the user necessitates real-time flight status information in context of airports, the function calling module 312 may initiate a caller function that in turn may trigger a called function from the API unit 134, specifying the required flight information system to determine information in real-time such as, but not limited to, gate changes, flight delays in context of airports.

Further, the airport information system may be used to determine information such as, but not limited to, security wait times, operational notices, etc. in context of airports. In an example, in case a passenger is running late for a flight and inquiries about time-sensitive information, the function calling module 312 may invoke a caller function that in turn invokes the called function for Airport System API that fetches real-time wait times at security checkpoints. The second LLM through the function calling module 312 may leverage the information to provide more tailored suggestions, such as exploring alternative options like TSA PreCheck or directions to nearby Helpdesks.

Further, the promotions and events tracking system may be used to determine information such as, but not limited to, discounts and promotions, events at the locations such as, but not limited to, retail spaces, shopping malls. Thus, the promotions and events tracking system may provide details about events, discounts and promotions related to shops, brands and overall shopping mall.

The user information determination module 314 may employ the one or more predefined functions registered with the function calling module 312 to determine user information as demographic information of the user and historical user data. In an example, the user information may include, but not be limited to, user profile data, behavioural history, real-time sensor input, spatial constraints data, an environmental condition, user goal data, and so on.

Further, the real-time data determination module 316 may employ the one or more predefined functions registered with the function calling module 312 to determine real-time data such as, but not limited to, inventory information, crowd monitoring information, promotion information, event information, live operational status, and status updates related to the first set of locations.

Further, the parameter determination module 318 may employ the one or more predefined functions registered with the function calling module 312 to determine the one or more parameters related to the one or more user preferences based on a processing of the user information, the first set of locations, the one or more user preferences, the local spatial layout of the subset of the ROI, the current location of the user and the real-time data.

Accordingly, the second set of locations determination module 310 may determine the second set of locations within the ROI and based on an analysis of the first set of locations, the one or more user preferences, user information, and the local spatial layout of a subset of the ROI that comprises the first set of locations. The second set of locations determination module 310 may refine the user query based on the real/exact names of the nodes, the user information, the one or more parameters, the real-time data as discussed above. Further, the second set of locations determination module 310 may determine one or more possible paths between the source and desired location regardless of optimality. The paths may be ranked based on the one or more parameters determined based on the user's preferences such as least crown, shorted distance, etc.

Further, the navigation instruction determination module 320 may determine by using the second LLM, a set of navigation instructions to reach the at least one desired location from the second set of locations based on the current location of the user. The second LLM may determine a second metadata associated with the second set of locations based on the one or more parameters related to the one or more user preferences such as, nodes with least crowd and serving coffee and operational at the time of receiving the navigation query in accordance with the example. The navigation instructions determination module 320 may provide the set of navigation instructions based on optimization of the one or more possible paths based on the one or more parameters. In accordance with the exemplary embodiment, for the navigation query “I would like to find the best path from Gate A1 to Starbucks with least crowding.”, the final response generated by the second LLM may be:

“The fastest path from Gate A1 to a Starbucks located near Gate B3. It's about 5-8 minutes walk. Follow the instructions below:
Exit Gate A1 and turn right
Follow the main concourse past security checkpoint 2 (currently no wait time, less crowd)
Take the escalator to level 2
Once you reach level 2, take right and move past IS Duty Free shop (about 20 m walk)
Starbucks will be on your left, next to Gate B3.
Current crowd level along this route is low. The shop closes in 2 hours. Would you like to see any additional details of Starbuck? Or would you like me to suggest another path?”

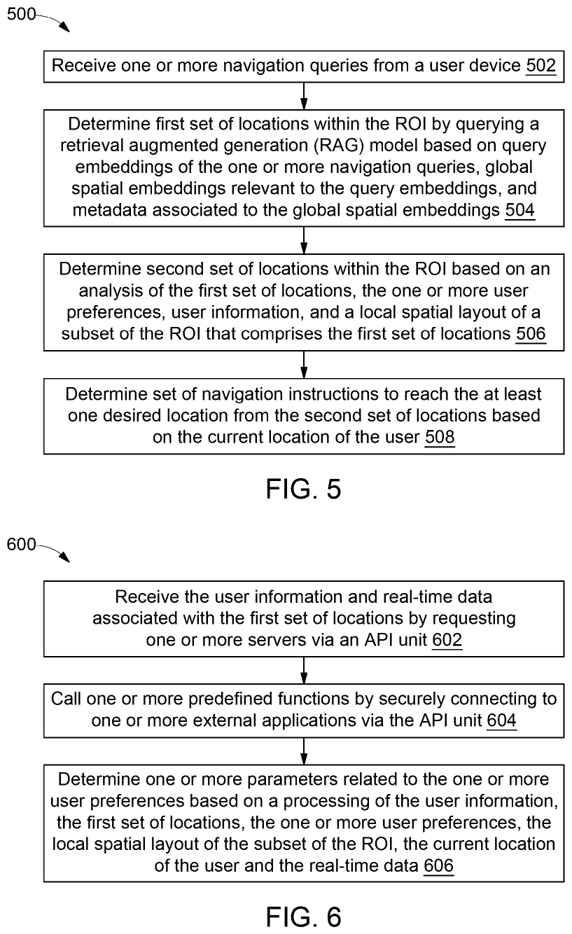

Referring to FIG. 5, a flow diagram 500 depicting a methodology of

providing AI-assisted navigation assistance to a user within a region of interest (ROI) is illustrated, in accordance with some embodiments of the present disclosure. In an embodiment, the flow diagram 500 may include a plurality of steps that may be performed by the processor 104 for providing AI-assisted navigation assistance to the user within the ROI.

At step 502, one or more navigation queries may be received from a user device including, but not limited to, a current location and one or more user preferences related to at least one desired location within the ROI. At step 504, a first set of locations within the ROI may be determined by querying a RAG model based on the query embeddings of the one or more navigation queries, global spatial embeddings relevant to the query embeddings, and first metadata associated to the global spatial embeddings. In an embodiment, the RAG model may determine the first set of locations based on a similarity analysis of the query embeddings, the first metadata and the global spatial embeddings. Further, the query embeddings of the one or more navigation queries may be generated by prompting the first LLM model. It is to be noted that the query embeddings may be the vector representations of the one or more navigation queries used to semantically align user intent with spatial data for relevant navigation instructions. Further, the global spatial embeddings may be determined based on a network-based layout of the ROI including, but not limited to, a plurality of nodes, one or more neighbours associated with each of the plurality of nodes and weighted spatial relationships between each of the plurality of nodes, and the first metadata including, but not limited to, operational metadata associated with each of the plurality of nodes in a JSON format. At step 506, a second set of locations within the ROI may be determined, by employing one or more predefined functions, based on an analysis of the first set of locations, the one or more user preferences, the user information, and the local spatial layout of a subset of the ROI that may include the first set of locations. Further, at step 508, a set of navigation instructions may be determined, by using the second LLM, to reach the at least one desired location from the second set of locations based on the current location of the user. The set of navigation instructions are generated by prompting the second LLM based on the first set of locations, the second set of locations, the second metadata associated with the second set of locations, a result of the analysis, and the one or more navigation queries.

Referring to FIG. 6, a flow diagram 600 of a methodology of determining a second set of locations as determined in step 506 of flow diagram 500 of FIG. 5, is illustrated, in accordance with some embodiments of the present disclosure.

At step 602, the user information and real-time data associated with the first set of locations may be received by requesting one or more servers via an API unit 134. In one example, the real-time data may include, but not limited to, inventory information, crowd monitoring information, promotion information, event information, live operational status, and status updates, and so on. Further, the user information may include, but not limited to, demographic information of the user and historical user data. At step 604, the one or more predefined functions may be called by securely connecting to one or more external applications via the API unit 134. At step 606, the one or more parameters related to the one or more user preferences may be determined, by employing the one or more predefined functions, based on a processing of the user information, the first set of locations, the one or more user preferences, the local spatial layout of the subset of the ROI, the current location of the user and the real-time data.

Thus, the disclosed method 500 and system 100 try to overcome the technical problem of providing navigation assistance to a user within a region of interest (ROI) using an AI. Since current navigation methods such as static maps or modern AR overlays often lack the ability to account for individual preferences and the user's region of interest, they fail to deliver a truly intuitive navigation experience specially in indoor environments. The disclosed method 500 and system 100 may address these limitations by utilizing an AI-assisted navigation assistance based on a one or more navigation queries from a user device.

In light of the above-mentioned advantages and the technical advancements provided by the disclosed method 500 and system 100, the claimed steps as discussed above are not routine, conventional, or well understood in the art, as the claimed steps enable the following solutions to the existing problems in conventional technologies. Further, the claimed steps bring an improvement in the functioning of the device itself as the claimed steps provide a technical solution to a technical problem.

The specification has described a method 500 and system 100 for providing AI-assisted navigation assistance to a user within a region of interest (ROI). The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor 104 may be stored. Thus, a computer-readable storage medium may store instructions for execution by one or more processors, including instructions for causing the processor(s) 104 to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, non-volatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A method of providing AI-assisted navigation assistance to a user within a region of interest (ROI), the method comprising:
receiving, by a processor, one or more navigation queries from a user device,
wherein the one or more navigation queries comprise a current location and one or more user preferences related to at least one desired location within the ROI;
determining, by the processor, a first set of locations within the ROI by querying a retrieval augmented generation (RAG) model based on query embeddings of the one or more navigation queries, global spatial embeddings relevant to the query embeddings, and first metadata associated with the global spatial embeddings;
determining, by the processor, by employing one or more predefined functions, a second set of locations within the ROI and based on an analysis of the first set of locations, the one or more user preferences, user information, and a local spatial layout of a subset of the ROI that comprises the first set of locations; and
determining, by the processor by using a Large Language Model (LLM), a set of navigation instructions to reach the at least one desired location from the second set of locations based on the current location of the user.

2. The method of claim 1, wherein the set of navigation instructions is generated by prompting the LLM based on the first set of locations, the second set of locations, second metadata associated with the second set of locations, a result of the analysis, and the one or more navigation queries.

3. The method of claim 2, wherein the global spatial embeddings and the local spatial layout are determined based on a network-based layout of the ROI, wherein the network-based layout comprises a plurality of nodes, one or more neighbors associated with each of the plurality of nodes and weighted spatial relationships between each of the plurality of nodes, and
wherein the first metadata and the second metadata comprises operational metadata associated with each of the plurality of nodes in a JSON format.

4. The method of claim 1, wherein the RAG model determines the first set of locations based on a similarity analysis of the query embeddings, the first metadata and the global spatial embeddings.

5. The method of claim 1, further comprises:
receiving, by the processor, the user information and real-time data associated with the first set of locations by requesting one or more servers via an API unit,
wherein the real-time data comprises inventory information, crowd monitoring information, promotion information, event information, live operational status, and status updates, and
wherein the user information comprises demographic information of the user and historical user data.

6. The method of claim 5, further comprises:
calling, by the processor, the one or more predefined functions by securely connecting to one or more external applications via the API unit; and
determining, by the processor by employing the one or more predefined functions, one or more parameters related to the one or more user preferences based on a processing of the user information, the first set of locations, the one or more user preferences, the local spatial layout of the subset of the ROI, the current location of the user and the real-time data.

7. A system for providing AI-assisted navigation assistance to a user within a region of interest (ROI), the system comprising:
a processor;
a memory communicably coupled to the processor, wherein the memory stores processor-executable instruction, which, on execution, cause the processor to:
receive one or more navigation queries from a user device,
wherein the one or more navigation queries comprise a current location and one or more user preferences related to at least one desired location within the ROI;
determine a first set of locations within the ROI by querying a retrieval augmented generation (RAG) model based on query embeddings of the one or more navigation queries, global spatial embeddings relevant to the query embeddings, and first metadata associated with the global spatial embeddings;
determine, by employing one or more predefined functions, a second set of locations within the ROI and based on an analysis of the first set of locations, the one or more user preferences, user information, and a local spatial layout of a subset of the ROI that comprises the first set of locations; and
determine, by using a Large Language Model (LLM), a set of navigation instructions to reach the at least one desired location from the second set of locations based on the current location of the user.

8. The system of claim 7, wherein the set of navigation instructions is generated by prompting the LLM based on the first set of locations, the second set of locations, second metadata associated with the second set of locations, a result of the analysis, and the one or more navigation queries.

9. The system of claim 7, wherein the global spatial embeddings are determined based on a network-based layout of the ROI, wherein the network-based layout comprises a plurality of nodes, one or more neighbors associated with each of the plurality of nodes and weighted spatial relationships between each of the plurality of nodes, and
wherein the first metadata comprises operational metadata associated with each of the plurality of nodes in a JSON format.

10. The system of claim 7, wherein the RAG model determines the first set of locations based on a similarity analysis of the query embeddings, the first metadata and the global spatial embeddings.

11. The system of claim 7, further comprises:
receive the user information and real-time data associated with the first set of locations by requesting one or more servers via an API unit,
wherein the real-time data comprises inventory information, crowd monitoring information, promotion information, event information, live operational status, and status updates, and
wherein the user information comprises demographic information of the user and historical user data.

12. The system of claim 11, further comprises:
call the one or more predefined functions by securely connecting to one or more external applications via the API unit; and
determine by employing the one or more predefined functions, one or more parameters related to the one or more user preferences based on a processing of the user information, the first set of locations, the one or more user preferences, the local spatial layout of the subset of the ROI, the current location of the user and the real-time data.

13. A non-transitory computer-readable medium storing computer-executable instructions for providing AI-assisted navigation assistance to a user within a region of interest (ROI), the computer-executable instructions configured for:
receiving one or more navigation queries from a user device,
wherein the one or more navigation queries comprise a current location and one or more user preferences related to at least one desired location within the ROI;
determining a first set of locations within the ROI by querying a retrieval augmented generation (RAG) model based on query embeddings of the one or more navigation queries, global spatial embeddings relevant to the query embeddings, and first metadata associated with the global spatial embeddings;
determining by employing one or more predefined functions, a second set of locations within the ROI and based on an analysis of the first set of locations, the one or more user preferences, user information, and a local spatial layout of a subset of the ROI that comprises the first set of locations; and
determining a set of navigation instructions to reach the at least one desired location from the second set of locations based on the current location of the user.

14. The non-transitory computer-readable medium of claim 13, wherein the set of navigation instructions is generated by prompting the LLM based on the first set of locations, the second set of locations, second metadata associated with the second set of locations, a result of the analysis, and the one or more navigation queries.

15. The non-transitory computer-readable medium of claim 14, wherein the global spatial embeddings and the local spatial layout are determined based on a network-based layout of the ROI, wherein the network-based layout comprises a plurality of nodes, one or more neighbors associated with each of the plurality of nodes and weighted spatial relationships between each of the plurality of nodes, and
wherein the first metadata and the second metadata comprises operational metadata associated with each of the plurality of nodes in a JSON format.

16. The non-transitory computer-readable medium of claim 13, wherein the RAG model determines the first set of locations based on a similarity analysis of the query embeddings, the first metadata and the global spatial embeddings.

17. The non-transitory computer-readable medium of claim 13, wherein the computer-executable instructions are further configured for:
receiving the user information and real-time data associated with the first set of locations by requesting one or more servers via an API unit,
wherein the real-time data comprises inventory information, crowd monitoring information, promotion information, event information, live operational status, and status updates, and
wherein the user information comprises demographic information of the user and historical user data.

18. The non-transitory computer-readable medium of claim 17, wherein the computer-executable instructions are further configured for:
calling the one or more predefined functions by securely connecting to one or more external applications via the API unit; and
determining one or more parameters related to the one or more user preferences based on a processing of the user information, the first set of locations, the one or more user preferences, the local spatial layout of the subset of the ROI, the current location of the user and the real-time data.
